(19) United States
(12) Patent Application Publication
(10) Pub. No.: US 2026/0298792 A1
(43) Pub. Date: Oct. 1, 2026

(54) APPARATUS AND METHOD FOR DETECTION OF CONTAMINANTS WITHIN FLUID-FILLED INERTIAL SENSORS

(71) Applicant: THE BOEING COMPANY, Arlington, VA (US)

(72) Inventors: Richard A Perfetta, Blacklick, OH (US); Bikash Khatiwoda, Pataskala, OH (US); Aubrey Tunberg, Heath, OH (US)

(73) Assignee: THE BOEING COMPANY, Arlington, VA (US)

(21) Appl. No.: 19/096,111

(22) Filed: Mar. 31, 2025

(51) Int. Cl. G01N 15/06; G01P 15/14; G01N 15/00

(52) U.S. Cl. CPC G01N 15/0637; G01P 15/14; G01N 2015/0053

(57) ABSTRACT

An apparatus and method for dynamic contamination detection in a fluid-filled inertial sensor are provided. A float of the sensor is disposed within a fluid-filled housing and is controlled to oscillate according to an input signal by a drive motor. This agitates fluid in the housing of the sensor such that contaminants are encouraged to contact the float. A difference between the oscillatory motion of the float and the input oscillation signal provided to the drive motor is identified. A presence and/or an amount of the contaminants within the fluid is identified based on this difference.

### BACKGROUND

### Technical Field

The present disclosure relates to detection of contaminants within fluids inside fluid-filled inertial sensors, such as pendulous integrating gyroscopic accelerometers (PIGAs).

### Description of the Art

Several inertial sensors include floats within a fluid to measure acceleration. These types of inertial sensors include PIGAs, fluid-damped pendulous accelerometers, fluid-floating gyroscopes and accelerometers, gas-floated accelerometers, and the like. These inertial sensors can measure acceleration of the devices or systems to which the sensors are coupled by integrating gyroscopic motion. A float is purposely unbalanced containing a gas bearing gyroscopic wheel and pendulous ring mass and is virtually neutrally buoyant in a high viscosity fluid. This float responds to acceleration of the sensor by moving in directions that oppose the acceleration. The movement of the float is related to (e.g., proportional to) this acceleration. A spinning gyroscopic wheel is connected to the float. A torque on this wheel causes gyroscopic processing responsive to acceleration being applied to the float. This wheel includes a drive motor that imparts a counter torque to keep the float in a null position. The amount of torque required to keep the float in a fixed position (or to return the float to the position prior to experiencing the acceleration) is proportional to the amount of acceleration.

One problem with these types of sensors, however, is contamination of the fluid within the sensors. Contaminants in the fluid can increase drift in measurement of the torque, wear and tear on the sensor components, or the like. For example, contact between the float and contaminants in the fluid can slow movement of the float and/or require more torque to maintain a position of the float, thereby leading to incorrect calculations of acceleration. The contaminants can include particulates, chemicals, or the like, in the fluid. Detection of contaminants is important, therefore, for accurate measurements of acceleration. This importance is even more prevalent in inertial navigation systems of aircraft or weapons.

Currently, fluid-filled inertial sensors are tested for contaminants by placing the sensors on tiltable surfaces, tilting the surfaces, and then waiting several minutes for the floats to move due to the tilting and then return to the original positions of the floats. The movements of the floats are examined to determine whether the movements are slower than expected or more torque is needed to return the floats to their original positions than expected. If the movements are slower and/or more torque is needed, then this can indicate that the floats contacted contaminants within the fluid.

But this technique relies on the floats contacting the contaminants within the fluid, which may not occur if the fluid is relatively still. The paths in which the floats move may not cross contaminants and, though present in the fluid, the floats do not contact the contaminants. This can result in contaminants not being detected.

In one example, an apparatus for dynamic contamination detection in a fluid-filled inertial sensor is provided. The apparatus includes a float disposed within a fluid-filled housing and configured to oscillate; a drive motor operatively coupled to the float and configured to impart oscillatory motion to the float according to an input oscillatory signal to agitate the fluid such that contaminants are encouraged to contact the float; and a controller in operative closed loop control with the float and the drive motor, the controller configured to identify a difference between the oscillatory motion of the float and the input oscillation signal provided to the drive motor, the controller configured to identify one or more of a presence or an amount of the contaminants within the fluid based on the difference that is identified.

In another example, a method for dynamically detecting contamination in a fluid-filled inertial sensor is provided. The method includes generating an input oscillatory signal; actuating a float positioned within a fluid-filled housing of the inertial sensor according to the input oscillatory signal using a drive motor to impart an oscillatory motion to the float such that the fluid is agitated to encourage contaminants in the fluid of the inertial sensor to contact the float; acquiring data representative of the oscillatory motion of the float; analyzing a difference between the oscillatory motion of the float represented by the data and the input oscillatory signal; and identifying one or more of a presence or an amount of contaminants in the fluid based on the difference that is analyzed.

In another example, an apparatus for dynamic contamination detection in a PIGA is provided. The apparatus includes a float disposed within a housing of the PIGA that contains a fluid, the float configured to be displaced in response to acceleration of the PIGA for measurement of the acceleration; a drive motor operatively coupled to the float; and a controller configured to close a control loop around an input oscillation signal to the drive motor to cause the drive motor to oscillate the float within the fluid in the PIGA at a predetermined oscillatory motion, the drive motor configured to oscillate the float within the fluid to agitate the fluid and contact one or more contaminants within the fluid, the controller configured to compare actual oscillatory motion of the float with the predetermined oscillatory motion, the controller configured to identify a presence or amount of the one or more contaminants in the fluid based on a difference between the actual oscillatory motion of the float and the predetermined oscillatory motion.

### BRIEF DESCRIPTION OF THE DRAWINGS

FIG. 1 illustrates one example of an apparatus for dynamic contamination detection in a fluid-filled inertial sensor.

FIG. 2 illustrates one example of an input oscillatory signal and actual oscillatory movements of a float of the sensor shown in FIG. 1.

FIG. 3 illustrates another example of the input oscillatory signal and actual oscillatory movements of the float.

FIG. 4 illustrates a flowchart of one example of a method for testing fluid in an inertial sensor for contaminants.

### DETAILED DESCRIPTION

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

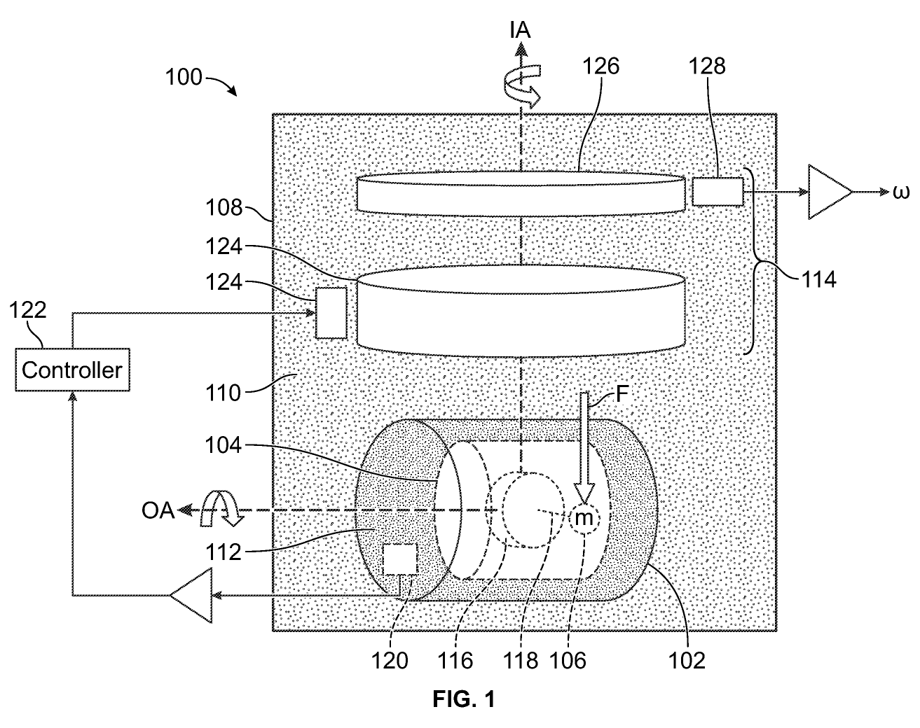

FIG. 1 illustrates one example of an apparatus 100 for dynamic contamination detection in a fluid-filled inertial sensor 108. The fluid-filled inertial sensor 108 includes an integrating gyroscope 102, driving motor and gear 126, all submerged in a fluid 110. The fluid-filled inertial sensor 108 is filled with a fluid 110 such as a fluorinated fluid, a perfluorinated liquid, a silicone oil, or the like. The integrating gyroscope 102 contains the float 104 and is immersed in damping fluid 112. The float 104 contains a gyroscope wheel 116 of a spinning wheel or gyroscopic wheel inside the damping fluid 112. The float 104 has a spherical mass 106, such as a metallic or metal alloy sphere in one example. The float 104 does not float on top of the damping fluid 112 within the integrating gyroscope 102, but instead is suspended within the damping fluid 112 such that the float 104 is not on top of the damping fluid 112 and is not at the bottom of the integrating gyroscope 102. The damping fluid 112 dampens motion of the float 104 while allowing the float 104 to freely move within the damping fluid 112. The float 104 is partially or completely submerged in the damping fluid 112, and the float 104 tilts or moves during acceleration of the fluid-filled inertial sensor 108. The damping fluid 108 makes the float 104 neutrally buoyant. For example, the float 104 neither sinks or rises in the fluid 108 in the absence of external accelerations other than gravity so that buoyancy forces do not act on the gyroscope wheel 116 and only the external accelerations act on the gyroscope wheel 116 (e.g., accelerations of the system or device to which the apparatus 100 is connected).

The mass 106 is connected with the gyroscope wheel 116by a linkage 118, such as a pivot point, flexural bearing, gimbal, torsion spring, or the like. When the drive assembly 114 accelerates, the float 104 responds to the acceleration with a force F proportional to the acceleration. The float 104 deflects or tilts in the direction of the acceleration in a distance that is proportional to the acceleration (e.g., with greater accelerations resulting in longer displacements of the float 104). For example, if the drive assembly 114 accelerates in a positive direction along an axis, the float 104 is displaced in a negative direction along the same axis.

A float pickoff device 120 is disposed in the damping fluid 112 with the float 104. The float pickoff device 120 measures displacement of the float 104. In one example, the float pickoff device 120 includes strain gauges attached to the float 104 or the linkage 118. The strain gauges change electrical resistance in response to being deformed by movement of the float 104 and/or linkage 118. This mechanical deformation is measured and indicates the displacement of the float 104. In another example, the float pickoff device 120 includes a fixed electrode that measures changes in capacitance between the float 104 and the electrode. Movement of the float 104 changes this capacitance, which is then used to measure movement of the float 104. In another example, the float pickoff device 120 includes a coil and a magnetic core attached to the float 104. Movement of the float 104 changes inductance of the coil. This change in inductance is used to measure movement of the float 104. In another example, the float pickoff device 120 includes light sensors (e.g., photodiodes or phototransistors) to detect position changes of a reflective surface attached to the float 104. Movement of the float 104 causes changes in the amount of reflected light, which represents displacement of the float 104.

The apparatus 100 includes a controller 122 that represents one or more processors that operate to perform the functions described herein in connection with the controller 122. The controller 122 represents one or more integrated circuits, microcontrollers, field programmable gate arrays, and the like. The controller 122 receives electrical signals output by the float pickoff device 120 that represent measurement displacement or movement of the float 104 (as measured by the float pickoff device 120).

The controller 122 is connected with an input axis (IA) drive motor 124 of the gyroscope wheel 116 that drives movement of the float 104. The IA drive motor 124 rotates a gear 126 that is connected with the gyroscope assembly to drive the float 104 to maintain the position of the float 104 (or return the float 104 to its position prior to acceleration). The IA drive motor 124 counteracts forces acting on the float 104 due to acceleration. As the apparatus 100 experiences acceleration, the float 104 moves and the IA drive motor 124 operates to correct or maintain the position of the float 104 to keep the float 104 in a desired orientation.

The controller 122 receives the output from the float pickoff device 120, and generates control signals that are output to the IA drive motor 124 based on the output from the float pickoff device 120. For example, if the output from the float pickoff device 120 indicates the float 104 has moved, the controller 122 sends a control signal to the IA drive motor 124. This control signal directs the IA drive motor 124 to rotate the gear 126 that is connected with the gyroscope wheel 116. This returns the float 104 to its original position (before experiencing acceleration) or maintains the float 104 in this position.

A digital pickoff (DPO) 128 is similar to the float pickoff device 120, but measures rotation of the gear 126. The gyroscope wheel 116 spins at a constant speed (or substantially constant speed within manufacturing tolerances) around or about a spin axis of the gyroscope wheel 116. This spin axis is coextensive with or extends along the linkage 118. The drive assembly 114 rotates the entire gyroscopic assembly (the components within the fluid-filled inertial sensor 108) around or about an IA axis (labeled IA in FIG. 1), which is equivalent to acceleration (thereby counteracting gyroscopic procession caused by acceleration of the float 104). The float pickoff device 120 measures the rate of rotation of the gear 126 and outputs the rate of rotation to the controller 122. The rate of rotation is proportional to the acceleration of the float 104. As a result, this measured rate of rotation is used to measure acceleration of the float 104.

The apparatus 100 tests the damping fluid 112 for contaminants, such as particles, which interfere with the free movement of the float 104. This ensures that the accelerations measured by the fluid-filled inertial sensor 108 are accurate in that the displacements of the float 104 due to contaminants are not inhibited. Inaccurate testing for contaminants often results in fluid-filled inertial sensors 108 that inaccurately measure acceleration, which can result in unsafe operation of aircraft, projectiles, or the like. In one example, the apparatus 100 tests for contaminants in the damping fluid 112 without requiring the addition of other devices to the fluid-filled inertial sensor 108. Stated differently, the apparatus 100 and fluid-filled inertial sensor 108 may include the same components for both measuring acceleration and testing for contaminants.

During testing for contaminants, the fluid-filled inertial sensor 108 and apparatus 100 are placed in a stationary state or condition. This avoids external accelerations interfering with contaminant detection. The controller 122 sends a control signal to the drive motor 124 that directs the drive motor 124 to rotate the gear 126 of the gyroscope wheel 116 according to an input oscillation signal. This rotation imparts a defined or designated oscillatory motion to the float 104 according to the input oscillation signal. In one example, the controller 122 directs the drive motor 124 to oscillate the float 104 within the damping fluid 112 at a predetermined frequency to agitate the damping fluid 112. This agitation stirs the damping fluid 112 and encourages contaminants within the damping fluid 112108 to contact the float 104 during oscillation. In contrast to some known testing apparatuses for inertial sensors, the controller 122 directs the drive motor 124 to oscillate the float 104 back and forth several times (e.g., ten oscillations, twenty oscillations, etc.) within a short time window (e.g., within ten seconds, within one minute, etc.). Some known testing apparatuses merely impart an acceleration on the sensor by tilting the sensor, which often requires several minutes for the float to move during the measurement for contamination. Therefore, the apparatus 100 described herein completes testing for contaminants must faster than known testing apparatuses.

Additionally, the controlled oscillation of the float 104 increases the likelihood that contaminants in the damping fluid 112 contact the float 104 (and therefore are detected by the apparatus 100) relative to some known testing apparatuses. The controlled oscillation agitates the damping fluid 112 (and contaminants to the extent the contaminants are present), which increases the likelihood that the contaminants move into the oscillatory pathway of the float 104 during testing (when compared with known testing apparatuses that do not agitate the damping fluid 112 aside from tilting the sensor).

The float pickoff device 120 measures the actual oscillatory movement of the float 104 during the controlled oscillation of the float 104. The float pickup device 120 communicates signals to the controller 122 that notify the sensed movements of the float 104. If the actual oscillatory movement of the float 104 (e.g., the movements of the float 104 measured by the float pickoff device 120) match or correspond with the input oscillation signal, then this match or correspondence indicates the absence of contact with the float 104 with contaminants in the damping fluid 112. If the actual oscillatory movement of the float 104 do not match or correspond with the input oscillation signal, then this lack of a match or correspondence indicates contact with the float 104 with contaminants in the damping fluid 112. As a result, the controller 122 identifies the presence and/or amount of the contaminants within the damping fluid 112. This is a closed control loop provided by the controller 122 to test for contaminants in the damping fluid 112.

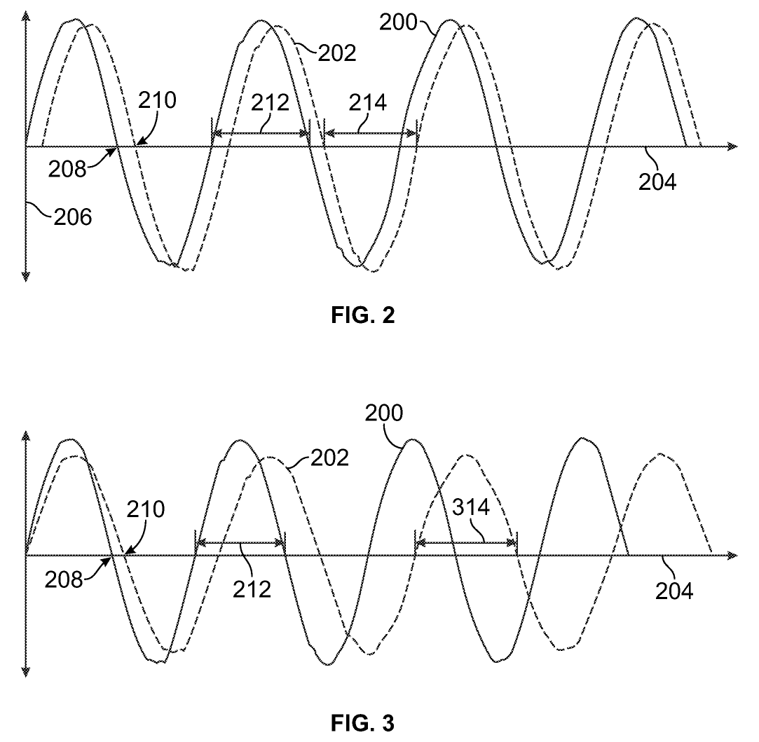

FIG. 2 illustrates one example of an input oscillatory signal 200 and actual oscillatory movements 202 of the float 104. The input oscillatory signal 200 and the actual oscillatory movements 202 of the float 104 are shown alongside a horizontal axis 204 representative of time and a vertical axis 206 representative of distance (or magnitude of directed or actual movement of the float 104). As shown, there is a phase difference between the actual oscillatory movements 202 of the float 104 and the input oscillatory signal 200. This phase difference is due to delay between rotation of the gear 126 by the drive motor 124 and the actual movement of the float 104 through the damping fluid 112.

In one example, the controller 122 compares the signal 200 with the movements 202 to identify differences between zero crossings 208, 210 in the signal 200 and the movements 202. The zero crossings 208 of the input oscillatory signal 200 represent the times (along the horizontal axis 204) at which the input oscillatory signal 200 cross over the horizontal axis 204. Similarly, the zero crossings 210 of the actual movements 202 of the float 104 represent the times at which the actual movements 202 of the float 104 cross over the horizontal axis 204. The controller 122 measures or calculates half-periods 212 between consecutive or sequential zero crossings 208 of the input oscillatory signal 200 and half-periods 214 between consecutive or sequential zero crossings 210 of the actual oscillatory movements 202 of the float 104. In one example, the controller 122 calculates an average or median of the half-periods 212 and an average of median of the half-periods 214. Alternatively, the controller 122 compares the half-periods 212 with the half-periods 214 without calculating an average or median.

If the controller 122 identifies a difference between the half-periods 212 and the half-periods 214 (or between the averages or medians of the half-periods 212, 214), then the controller 122 determines that contaminants are present in the damping fluid 112. If the controller 122 identifies no difference between the half-periods 212 and the half-periods 214 (or between the averages or medians of the half-periods 212, 214), then the controller 122 determines that no contaminants are present in the damping fluid 112. In one example, the controller 122 identifies contaminants within the damping fluid 112 responsive to this difference (between the half-periods 212, 214 or between the averages or medians of the half-periods 212, 214) exceeding a predefined threshold, such as at least ten percent of the period of the input oscillatory signal 200.

In the example shown in FIG. 2, the controller 122 compares the half-periods 212, 214 (or the averages or medians thereof) and decides that there is no difference. As a result, the controller 122 does not identify the presence of contaminants within the damping fluid 112.

FIG. 3 illustrates another example of the input oscillatory signal 200 and actual oscillatory movements 302 of the float 104. The input oscillatory signal 200 and the actual oscillatory movements 302 of the float 104 are shown alongside the horizontal axis 204 and the vertical axis 206 described above. Zero crossings 310 and half-periods 314 of the actual oscillatory movements 302 of the float 104 are identified by the controller 122.

In contrast to the example shown in FIG. 2, the controller 122 identifies the zero-crossings 208 of the input oscillatory signal 200 and zero-crossings 310 of the actual oscillatory movements 302 of the float 104. The controller 122 then calculates the half-periods 212 of the input oscillatory signal 200 and half-periods 314 of the actual oscillatory movements 302 of the float 104. The controller 122 compares these half-periods 212, 314 and decides that the half-periods 314 of the actual oscillatory movements 302 of the float 104 are longer than the half-periods 212 of the input oscillatory signal 200. This indicates that the float 104 is oscillating slower than directed according to the input oscillatory signal 200. The controller 122 identifies this as representing the presence of contaminants in the damping fluid 112, as the float 104 is contacting the contaminants in the damping fluid 112 during movement, which slows the float 104.

In another example, the controller 122 compares the input oscillatory signal and the actual oscillatory movements of the float 104 with each other, and calculate or measure the enclosed area or bounded region between the curves formed by the input oscillatory signal and the actual oscillatory movements. This area or region also is referred to as a phase-dependent envelope or modulation region between the signal and the movements. The area or region is calculated by the controller 122 as an integral between the curves formed by the input oscillatory signal and the actual oscillatory movements of the float 104. The controller 122 calculates the enclosed area or bounded region over or throughout a half-period of the input oscillatory signal, over or throughout a full period of the input oscillatory signal, over or throughout three or more half-periods of the input oscillatory signal, or over or throughout two or more full periods of the input oscillatory signal.

The controller 122 compares the bounded region or enclosed area that is calculated with one or more thresholds to identify the presence of contaminants in the damping fluid 112. For example, if the calculated region or area exceeds a threshold, then the controller 122 decides that there are contaminants in the damping fluid 112. Otherwise, the controller 122 decides that there are no contaminants in the damping fluid 112.

In one example, the controller 122 not only identifies the presence of contaminants in the damping fluid 112, but also estimates the amount of contaminants in the fluid 108. The amount of contaminants can be estimated by the controller 122 as a concentration of the contaminants in the damping fluid 112 (e.g., parts per million), as a percentage by weight or volume of the damping fluid 112, or the like. The controller 122 compares the calculated difference between the input oscillatory signal with the actual oscillatory movements of the float 104 with different thresholds. As described above, this difference can be a difference between zero-crossings or a bounded region between the signal and movements. Different thresholds are stored in an internal or external memory accessible to the controller 122. The memory is a tangible and non-transitory computer readable storage medium, such as a computer hard drive, optical disc, flash drive, or the like. These thresholds are associated with different amounts of contaminants, with larger thresholds associated with larger amounts of contaminants. The controller 122 decides which, if any, of the thresholds are exceeded by the calculated difference. The controller 122 then selects the contaminant amount associated with the largest of these exceeded thresholds as being the amount of contaminants in the damping fluid 112.

In one embodiment, the controller 122 dynamically changes the input oscillatory signal provided to the drive motor 124 to dynamically change the oscillatory motion of the float 104. The controller 122 dynamically changes the input oscillatory signal based on one or more differences identified by the controller 122 between the input oscillatory signal and the movements of the float 104. This dynamically changes the oscillatory motion of the float 104 accordingly. In one example, the controller 122 increases the frequency of the input oscillatory signal responsive to not detecting any contaminants using a lower frequency input oscillatory signal. The controller 122 progresses through several different increasing frequencies until an upper frequency limit is reached or contaminants are detected. This helps to agitate the damping fluid 112 and increase the likelihood of detecting contaminants in the damping fluid 112.

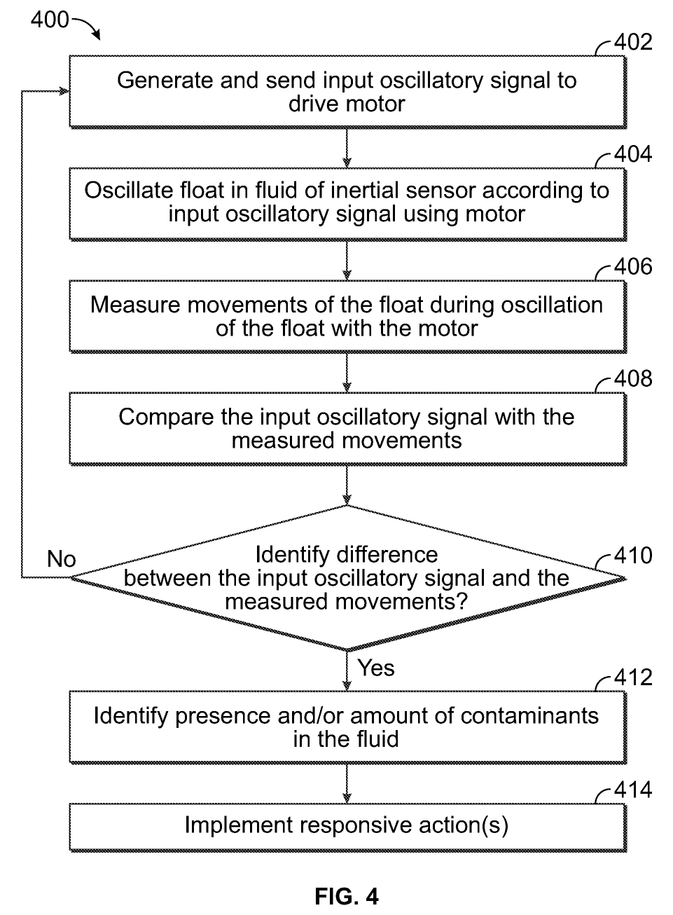

FIG. 4 illustrates a flowchart of one example of a method 400 for testing fluid in an inertial sensor for contaminants. The method 400 represents operations performed by the apparatus 100 shown in FIG. 1 in one embodiment. At 402, an input oscillatory signal is generated and sent to a drive motor of the inertial sensor. This input oscillatory signal is generated and sent by a controller of the inertial sensor in one example.

At 404, a float of the inertial sensor is oscillated in the fluid of the sensor according to the input oscillatory signal using the drive motor. The drive motor of the sensor moves the fluid back-and-forth in an oscillatory motion according to this signal to agitate the fluid and encourage contaminants in the fluid to contact the float. The drive motor oscillates the float back-and-forth several times in relatively quick succession, such as up-and-down in the fluid between an uppermost position and a lowermost position every five seconds (e.g., a frequency of five Hertz). This speeds up the process for testing for contaminants relative to some known techniques for testing for contaminants in the fluids of the sensors.

At 406, movements of the float are measured during the oscillatory movement of the float. The movements are measured by one or more pickups in the sensor, such as the float pickup device. At 408, the input oscillatory signal and the measured movements of the float are compared with each other. As described above, this comparison can involve calculating and comparing zero-crossings of the signal and movements, half-periods of the signal and movements, periods of the signal and movements, enclosed areas or bounded regions of the signal and movements with each other.

At 410, a decision is made as to whether there is a difference between the input oscillatory signal and the measured movements. The difference is between the zero-crossings, between the half-periods, between the full periods, or between the enclosed areas or bounded regions that are compared at 408 in different examples. If a difference is identified, then this indicates the presence and/or amount of contaminants in the fluid of the inertial sensor. As a result, flow of the method 400 can proceed toward 412. Otherwise, flow of the method 400 terminates or returns to another operation (e.g., 402) to repeatedly test the fluid for contaminants.

At 412, the presence and/or amount of contaminants in the fluid is identified. In one example, the difference identified at 410 is compared to a threshold associated with the presence of contaminants. This threshold is set empirically in one embodiment. For example, one or more inertial sensors known as having contaminants in the fluid(s) of the sensor(s) are tested as described above, with the difference(s) identified at 410 used to set the threshold (e.g., by calculating an average or median). As another example, the threshold is manually set by an operator of the apparatus 100.

The amount of contaminants in the fluid is identified in one embodiment by comparing the difference to multiple, different thresholds. As described above, each threshold is associated with a different amount of contaminants in the fluid. The thresholds are set empirically in one embodiment. For example, inertial sensors known as having different amounts of contaminants in the fluids of the sensors are tested as described above. The differences identified at 410 are calculated for these sensors and used to set the thresholds. As another example, the thresholds are manually set by an operator of the apparatus 100.

At 414, one or more responsive actions are implemented. One responsive action includes sending an alert signal from the controller to an external device (e.g., a display, lamp, speaker, etc.) that warns an operator of the detected contaminants. Another responsive action includes the controller sending a signal that prevents operation of the inertial sensor. For example, the controller sends a deactivation signal that shuts down the inertial sensor as the sensor is no longer reliable given the detected contaminants. As another example, the controller sends the deactivation signal to a larger system that includes or uses the inertial sensor for operation. For example, the controller sends a signal to a controller of an aircraft (or other vehicle), weapon (e.g., missile), or the like. This signal notifies the larger system that the inertial sensor is no longer reliable and prevents the larger system from using the inertial sensor. The aircraft switches to using another inertial sensor or avoids departure with that sensor. The weapon (e.g., missile) prevents deployment to avoid inaccurate targeting using that inertial sensor. In another example, the method 400 does not include 414.

The apparatus 100 and/or method 400 are used prior to installation of the fluid-filled inertial sensor 108 in one example. The apparatus 100 and/or method 400 tests the fluid-filled inertial sensors 108 prior to installation of the fluid-filled inertial sensors 108 in the larger systems. The apparatus 100 and/or method 400 are used after installation to check (or repeatedly check) contamination of the damping fluid 112 in the fluid-filled inertial sensor 108, after the fluid-filled inertial sensor 108 is installed in the larger system. This helps prevent reliance of the larger system on the fluid-filled inertial sensor 108 if the damping fluid 112 in the fluid-filled inertial sensor 108 becomes contaminated after installation.

Further, the disclosure comprises examples according to the following clauses:

Clause 1: An apparatus for dynamic contamination detection in a fluid-filled inertial sensor, the apparatus comprising: a float disposed within a fluid-filled housing and configured to oscillate; a drive motor operatively coupled to the float and configured to impart oscillatory motion to the float according to an input oscillatory signal to agitate the fluid such that contaminants are encouraged to contact the float; and a controller in operative closed loop control with the float and the drive motor, the controller configured to identify a difference between the oscillatory motion of the float and the input oscillation signal provided to the drive motor, the controller configured to identify one or more of a presence or an amount of the contaminants within the fluid based on the difference that is identified.

Clause 2: The apparatus of Clause 1, wherein the controller is configured to identify the difference based on a zero crossing difference between the oscillatory motion of the float and the input oscillation signal.

Clause 3: The apparatus of Clause 1, wherein the controller is configured to identify the difference based on an integral between the oscillatory motion of the float and the input oscillation signal.

Clause 4: The apparatus of Clause 1, wherein the controller is configured to control the drive motor to impart the oscillatory motion to the float using the input oscillation signal provided to the drive motor.

Clause 5: The apparatus of Clause 1, wherein the controller is configured to identify the one or more of the presence or the amount of the contaminants based on a size of the difference that is identified.

Clause 6: The apparatus of Clause 1, wherein the controller is configured to dynamically change the input oscillation signal that is communicated to the drive motor to dynamically change the oscillatory motion of the float based on the difference that is identified.

Clause 7: The apparatus of Clause 1, wherein the controller is configured to identify the one or more of the presence or the amount of the contaminants using known differences between the input oscillation signal and the oscillatory motion of the float that are associated with one or more of different predetermined contaminants or different predetermined amounts of the predetermined contaminants.

Clause 8: A method for dynamically detecting contamination in a fluid-filled inertial sensor, the method comprising: generating an input oscillatory signal; actuating a float positioned within a fluid-filled housing of the inertial sensor according to the input oscillatory signal using a drive motor to impart an oscillatory motion to the float such that the fluid is agitated to encourage contaminants in the fluid of the inertial sensor to contact the float; acquiring data representative of the oscillatory motion of the float; analyzing a difference between the oscillatory motion of the float represented by the data and the input oscillatory signal; and identifying one or more of a presence or an amount of contaminants in the fluid based on the difference that is analyzed.

Clause 9: The method of Clause 8, wherein the difference is analyzed using a zero crossing difference between the oscillatory motion of the float and the input oscillation signal.

Clause 10: The method of Clause 8, wherein the difference is analyzed using an integral between the oscillatory motion of the float and the input oscillation signal.

Clause 11: The method of Clause 8, wherein the drive motor receives the input oscillatory signal and moves the float according to the input oscillation signal.

Clause 12: The method of Clause 8, wherein the one or more of the presence or the amount of the contaminants is identified based on a size of the difference that is identified.

Clause 13: The method of Clause 8, further comprising: dynamically changing the input oscillation signal that is communicated to the drive motor to dynamically change the oscillatory motion of the float based on the difference that is identified.

Clause 14: The method of Clause 8, wherein the one or more of the presence or the amount of the contaminants is identified using known differences associated with one or more of different predetermined contaminants or different predetermined amounts of the predetermined contaminants.

Clause 15: An apparatus for dynamic contamination detection in a pendulous integrating gyroscopic accelerometer (PIGA), the apparatus comprising: a float disposed within a housing of the PIGA that contains a fluid, the float configured to be displaced in response to acceleration of the PIGA for measurement of the acceleration; a drive motor operatively coupled to the float; and a controller configured to close a control loop around an input oscillation signal to the drive motor to cause the drive motor to oscillate the float within the fluid in the PIGA at a predetermined oscillatory motion, the drive motor configured to oscillate the float within the fluid to agitate the fluid and contact one or more contaminants within the fluid, the controller configured to compare actual oscillatory motion of the float with the predetermined oscillatory motion, the controller configured to identify a presence or amount of the one or more contaminants in the fluid based on a difference between the actual oscillatory motion of the float and the predetermined oscillatory motion.

Clause 16: The apparatus of Clause 15, wherein the controller is configured to identify the difference as a zero crossing difference between the actual oscillatory motion and the predetermined oscillatory motion.

Clause 17: The apparatus of Clause 15, wherein the controller is configured to identify the difference as an integral between the actual oscillatory motion and the predetermined oscillatory motion.

Clause 18: The apparatus of Clause 15, wherein the controller is configured to identify the presence or the amount of the one or more contaminants based on a size of the difference that is identified.

Clause 19: The apparatus of Clause 15, wherein the controller is configured to dynamically change the input oscillation signal that is communicated to the drive motor based on the difference that is identified.

Clause 20: The apparatus of Clause 15, wherein the controller is configured to identify the presence or the amount of the one or more contaminants using known differences associated with one or more of different predetermined contaminants or different predetermined amounts of the predetermined contaminants.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An apparatus for dynamic contamination detection in a fluid-filled inertial sensor, the apparatus comprising:
a float disposed within a fluid-filled housing and configured to oscillate;
a drive motor operatively coupled to the float and configured to impart oscillatory motion to the float according to an input oscillatory signal to agitate the fluid such that contaminants are encouraged to contact the float; and
a controller in operative closed loop control with the float and the drive motor, the controller configured to identify a difference between the oscillatory motion of the float and the input oscillation signal provided to the drive motor, the controller configured to identify one or more of a presence or an amount of the contaminants within the fluid based on the difference that is identified.

2. The apparatus of claim 1, wherein the controller is configured to identify the difference based on a zero crossing difference between the oscillatory motion of the float and the input oscillation signal.

3. The apparatus of claim 1, wherein the controller is configured to identify the difference based on an integral between the oscillatory motion of the float and the input oscillation signal.

4. The apparatus of claim 1, wherein the controller is configured to control the drive motor to impart the oscillatory motion to the float using the input oscillation signal provided to the drive motor.

5. The apparatus of claim 1, wherein the controller is configured to identify the one or more of the presence or the amount of the contaminants based on a size of the difference that is identified.

6. The apparatus of claim 1, wherein the controller is configured to dynamically change the input oscillation signal that is communicated to the drive motor to dynamically change the oscillatory motion of the float based on the difference that is identified.

7. The apparatus of claim 1, wherein the controller is configured to identify the one or more of the presence or the amount of the contaminants using known differences between the input oscillation signal and the oscillatory motion of the float that are associated with one or more of different predetermined contaminants or different predetermined amounts of the predetermined contaminants.

8. A method for dynamically detecting contamination in a fluid-filled inertial sensor, the method comprising:
generating an input oscillatory signal;
actuating a float positioned within a fluid-filled housing of the inertial sensor according to the input oscillatory signal using a drive motor to impart an oscillatory motion to the float such that the fluid is agitated to encourage contaminants in the fluid of the inertial sensor to contact the float;
acquiring data representative of the oscillatory motion of the float;
analyzing a difference between the oscillatory motion of the float represented by the data and the input oscillatory signal; and
identifying one or more of a presence or an amount of contaminants in the fluid based on the difference that is analyzed.

9. The method of claim 8, wherein the difference is analyzed using a zero crossing difference between the oscillatory motion of the float and the input oscillation signal.

10. The method of claim 8, wherein the difference is analyzed using an integral between the oscillatory motion of the float and the input oscillation signal.

11. The method of claim 8, wherein the drive motor receives the input oscillatory signal and moves the float according to the input oscillation signal.

12. The method of claim 8, wherein the one or more of the presence or the amount of the contaminants is identified based on a size of the difference that is identified.

13. The method of claim 8, further comprising:
dynamically changing the input oscillation signal that is communicated to the drive motor to dynamically change the oscillatory motion of the float based on the difference that is identified.

14. The method of claim 8, wherein the one or more of the presence or the amount of the contaminants is identified using known differences associated with one or more of different predetermined contaminants or different predetermined amounts of the predetermined contaminants.

15. An apparatus for dynamic contamination detection in a pendulous integrating gyroscopic accelerometer (PIGA), the apparatus comprising:
a float disposed within a housing of the PIGA that contains a fluid, the float configured to be displaced in response to acceleration of the PIGA for measurement of the acceleration;
a drive motor operatively coupled to the float; and
a controller configured to close a control loop around an input oscillation signal to the drive motor to cause the drive motor to oscillate the float within the fluid in the PIGA at a predetermined oscillatory motion, the drive motor configured to oscillate the float within the fluid to agitate the fluid and contact one or more contaminants within the fluid, the controller configured to compare actual oscillatory motion of the float with the predetermined oscillatory motion, the controller configured to identify a presence or amount of the one or more contaminants in the fluid based on a difference between the actual oscillatory motion of the float and the predetermined oscillatory motion.

16. The apparatus of claim 15, wherein the controller is configured to identify the difference as a zero crossing difference between the actual oscillatory motion and the predetermined oscillatory motion.

17. The apparatus of claim 15, wherein the controller is configured to identify the difference as an integral between the actual oscillatory motion and the predetermined oscillatory motion.

18. The apparatus of claim 15, wherein the controller is configured to identify the presence or the amount of the one or more contaminants based on a size of the difference that is identified.

19. The apparatus of claim 15, wherein the controller is configured to dynamically change the input oscillation signal that is communicated to the drive motor based on the difference that is identified.

20. The apparatus of claim 15, wherein the controller is configured to identify the presence or the amount of the one or more contaminants using known differences associated with one or more of different predetermined contaminants or different predetermined amounts of the predetermined contaminants.
